(19) United States
(12) Patent Application Publication
(10) Pub. No.: US 2006/0167680 A1
(43) Pub. Date: Jul. 27, 2006

(54) System and method for optimizing run-time memory usage for a lexicon

(75) Inventors: Jilei Tian, Tampere (FI); Jani Nurminen, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/042,445

(22) Filed: Jan. 25, 2005

(51) Int. Cl. G06F 17/21

(52) U.S. Cl. 704/10

(57) ABSTRACT

A system and method of extracting information from a lexicon and using the information with a computer software program. Lexicon data is arranged for a particular language using Unicode values or other uniquely defined code values for each character of word of the language. A location array is then created for the lexicon data arranged by Unicode value or other uniquely defined code value. Upon a request to search for a word, words that have the same initial character as the searched-for word are identified using the location array. The identified words are then searched for an identified word that matches the searched-for word. Therefore, the amount of data loaded into run-time memory is minimized, and searches for a given word are completely more quickly than in conventional systems.

### FIELD OF THE INVENTION

The present invention relates generally to speech and language processing techniques. More particularly, the present invention relates to systems that require lexicon minimization and fast search capabilities when the language at issue has a relatively large character set, such as the Chinese language.

### BACKGROUND OF THE INVENTION

Speech and language processing techniques, such as automatic speech recognition (ASR) and text-to-speech (TTS) synthesis, are constantly becoming increasingly important in multimedia systems. Many of these multimedia systems require a lexicon or dictionary for particular languages. A lexicon typically contains a great deal of information, including words, pronunciations, part-of-speech (POS), and other syntactic and semantic information. POS is a primitive form of linguistic theory that posits a restricted inventory of word-type categories such as nouns, verbs, etc. Such lexicons therefore normally require a large amount of memory.

Because of these memory issues, when a system processes text by using lexicon data, the lexicon data requires a very high run-time memory footprint and a time-consuming search. This particularly applies to the Chinese language and other languages with a large character set. For the Chinese language, for example, this is due to the fact that there are at least 20,901 Chinese characters (in a closed set) and more than 100,000 Chinese words (in an open set). A Chinese character is a basic written unit and is denoted by two bytes in Unicode. Unicode provides a unique number for every character, regardless of the platform, the program, and the language. The whole set of Chinese characters contains 20,901 characters, including the simplified and the traditional character sets. In the Unicode chart, Chinese characters are represented using the range from 4E00 to 9FA5. A Chinese character has ambiguous meanings and may have multiple pronunciations. Pronunciation of Chinese character is presented by monosyllable pinyin. A Chinese word is a sequence of Chinese characters without separators. For example, for a given word consisting of N characters, can denoted as an array word[N]. In this particular arrangement, word[0] stands for the Unicode value of the first character in the word.

Until now, conventional systems having lexicon data from a similarly complex language typically have been realized on other platforms than embedded systems, where the memory and processing power were not major implementation bottlenecks. For this reason, memory and speed optimization issues for handling lexicon data have not been seriously addressed in the past.

When processing Chinese lexicon data, the system normally downloads the whole data into a memory unit and assigns the data to predefined data structures. Alternatively, the whole data can be split into N parts and loaded one small part at a time. Although run-time memory can be reduced to some extent when more data partitions are enabled, the system still needs to load the whole lexicon data (by distributing or balancing the load over time), and either repeatedly scan the given text with each partition of the data, or load the partitioned data repeatedly. This leads to the very frequent data transfer from file to memory and increases the text processing time.

### SUMMARY OF THE INVENTION

The present invention addresses the issues identified above by introducing an intermediate location variable. The intermediate location variable serves as a bridge between the lexicon database and a given text. Only location data is extracted and loaded from the lexicon data and stored in the run-time memory. Therefore, the amount of data in run-time memory is significantly reduced. Furthermore, given a word, the corresponding location value can be obtained directly without a time-consuming search. This results in a significant reduction in search time as well.

The present invention can be applied to virtually any system that requires a Chinese lexicon or a lexicon for other languages with large character sets such as Japanese. In particular, the present invention can be an integral part of Chinese ASR and TTS systems, and the present invention enables a system to achieve a very low run-time memory, fast search and reduced lexicon data size without any loss of text processing accuracy. For example and in one reference implementation, in a Chinese TTS system, the run-time memory footprint for a lexicon was reduced from 4.5 MB to 63 kB with the present invention, i.e. the size was reduced to 1/76 of the original size. The present invention can be implemented in conjunction with a wide variety of voice user interface software programs.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a flow chart showing a process for the implementation of one embodiment of the present invention;

FIG. 2 is a perspective view of a mobile telephone that can be used in the implementation of the present invention; and

FIG. 3 is a schematic representation of the telephone circuitry of the mobile telephone of FIG. 2.

### DETAILED DESCRIPTION OF THE PREFERRED EMBODIMENTS

The present invention involves the introduction of an intermediate location variable. The intermediate location variable serves as a bridge between the lexicon database and a given text. Only location data is extracted and loaded from the lexicon database and stored in the run-time memory. Therefore, the amount of data in run-time memory is significantly reduced. Furthermore, given a word, the corresponding location value can be obtained directly without a time-consuming search. This results in a significant reduction in search time as well.

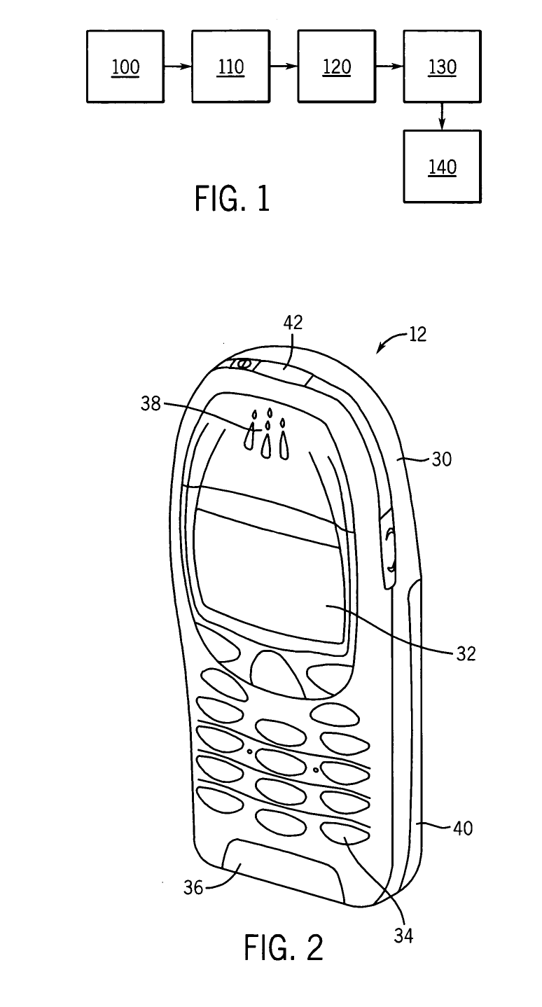

FIG. 1 is a flow chart showing the implementation of one embodiment of the present invention. In the case of the Chinese language, the Chinese lexicon data is arranged in ascending order by Unicode values for the words. It should be noted that, although the examples provided herein discusses the use of Unicode values, the present invention can use virtually any set of uniquely defined code values and is not limited to Unicode values. This is represented at step 100. For example, the data can be stored in the stream of:
Basic_info→item[0]→ . . . →item[Word_Number-1]

Basic_info contains information such as the version, the number of words, the number of POS, etc. Additional pieces of information can also be included in various embodiments of the present invention. Each item is presented in the stream of:
word[Character_Number]→pronunciation→pos→multiple_pronunciations→multiple_pos;

Ascending order means that for any i between 0 and a number of words, there is
item[i].word[0]≧item[i−1].word[0]

where item[i].word is the Unicode sequence and word[i] is the Unicode value of the i+1-th character in the word.

When processing the lexicon data, instead of loading the whole lexicon data into the run-time memory, a location array location[Character_Number] is established at step 110. Location variable location[i] indicates the length from the beginning of the lexicon data file to the first item whose first character has a Unicode value derived from i. Known Chinese characters are defined in the range of 4E00 and 9FA5 in the Unicode chart. Since the size of lexicon data is usually about 1 MB, 3 Bytes (0-4 MB) are more than enough to represent one entry in the location array.

The location array can be defined as:
#define CHARACTER_NUMBER 20,901
#define LOCATION_SIZE 3
#define UNICODE_START 4E00
location=malloc(CHARACTER_NUMBER *LOCATION_SIZE);

Location values can be extracted from lexicon data. The reference algorithm for extracting location information is shown below:

```
For i=0
For i = 0 to CHARACTER_NUMBER − 1{
  location[i] = −1
  }
unicode_value = item[0]word[0]
location[unicode_value − UNICODE_START] = location of item[0]
For i = 1 to CHARACTER_NUMBER − 1{
  if item[i]word[0]and ≠ item[i−1]word[0]
  then{ unicode_value =item[i]word[0]
    location[unicode_value − UNICODE_START] = location of
    item[i] }
  }
```

Searching any given word from the lexicon file can be accomplished very quickly. The first step, which is represented at step 120, is to locate the lexicon entries that contain a matching initial character:
unicode_value=word[0];
start=location[unicode_value-UNICODE_START];
length=location[next_unicode_value-UNICODE_START]-location[unicode_value-UNICODE_START];

In the above pseudo code, next_unicode_value is the next unicode_value for which location[next_unicode_value] is not −1.

The next step, represented at step 130, is to load the length size data from start in the lexicon data file, and save it into the run-time memory. Loaded data is usually very small (on the order of less than 1 KB) and a binary search, represented at step 140, can be applied to find matching item to given word within a very small range. Alternatively, the search can be performed during the loading process. With this technique, it is possible to limit the size of the memory block needed for the loaded data to the maximum size of a single lexicon entry.

The location data can be extracted on-line during the initialization phase. However, the location data is preferably extracted during the off-line processing of lexicon data, and then stored as part of the lexicon data. This process does not necessarily increase the lexicon data size. If the location data is stored in the lexicon data, the first character of every word is already known, so the first character becomes redundant and can be omitted. For example, in the case of given text[], the code value of the first character in the text string (text[]) is unicode_value=text[0]. The start and length can then be used as mentioned above. The first character of all words between start and start+length in the lexicon data has the same Unicode value of unicode_value; there is therefore no need to store that information.

In order to better understand the outcome of the memory optimization system and method of the present invention, the following analysis is shown being carried out on the Chinese lexicon used in one high quality text-to-speech system as a reference.

The lexicon data of this example contains 20,901 Chinese characters (full Unicode set), 92,901 words and 68 POS. The size of the lexicon data in the file is 1,119,707 bytes. After loading the lexicon data into data structures in the run-time memory, the size is 4,771,860 bytes. The maximum memory used in this particular system is 8,859,922 bytes. This indicates that the run-time memory usage must be reduced for embedded platforms.

Because the size of the lexicon data is about 1 MB, 3 Bytes (0-4 MB) are sufficient to represent the location information. The number of different characters is 20,901, so the size of the location array is 20,901×3=62,703 Bytes=61.2 KB, which represents about 5% of the total lexicon data.

Since the loaded lexicon data in the run-time memory takes 4,771,860 bytes and the number of characters is 20,901, the average size of each character in run-time memory is 228 bytes. In total, the average run-time memory required by the system and method of the present invention is 62,703+228=62,931=61.5 KB. The gain on memory usage between a conventional system and a system incorporating the present invention is 4,771,860/62,931=a factor of 76. The search complexity is also reduced because each search is only conducted on a small amount of data, rather than on the whole database as was required in a conventional system.

Regarding the lexicon data, the location information takes a 61.2 KB overhead, but all of the first characters can be removed with size of 92,901 (number of words)×2 (two bytes of each character)=185,802 Bytes. In this case, the lexicon data savings is 185,802−62,931=122,871 Bytes=120 KB. Thus, in addition to other advantages, about 10% a size reduction of the lexicon data file is also obtained with the present invention.

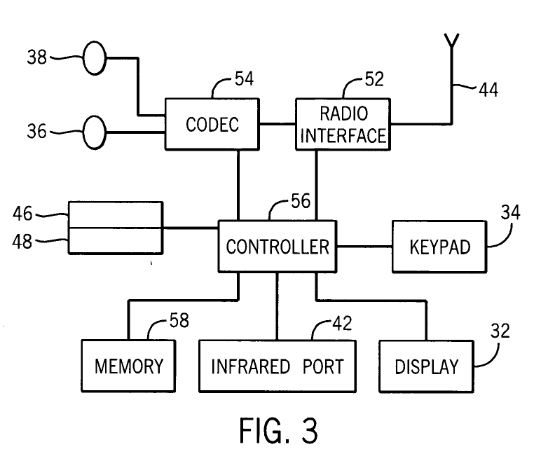

FIGS. 2 and 3 show one representative mobile telephone 12 within which the present invention may be implemented. It should be understood, however, that the present invention is not intended to be limited to one particular type of mobile telephone 12 or other electronic device. For example, the present invention can be incorporated into personal digital assistants (PDAs), integrated messaging devices (IMDs), notebook computers, handheld computers, and other devices. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of extracting information from a lexicon and using the information with a computer software program, comprising the steps of:
arranging lexicon data for a language using uniquely defined code values for characters of words included in the lexicon;
creating a location array for the lexicon data arranged by uniquely defined code value;
upon a request to search for a word, identifying words having a matching initial character as the searched-for word using the location array; and
searching through the identified words for an identified word that matches the searched-for word.

2. The method of claim 1, further comprising the step of, before or during searching through the identified words for an identified word that matches the searched-for word, loading one or more words having the same initial character as the searched-for-word.

3. The method of claim 1, wherein the lexicon data is arranged in ascending order by uniquely defined code value.

4. The method of claim 1, wherein the language is Chinese.

5. The method of claim 1, wherein the language is Japanese.

6. The method of claim 1, wherein the computer software program comprises a speech recognition program.

7. The method of claim 1, wherein the computer software program comprises a text-to-speech synthesis program.

8. A computer program product for extracting information from a lexicon and using the information with a computer software program, comprising:
computer code for arranging lexicon data for the language using uniquely defined code values for characters of words included in the lexicon;
computer code for creating a location array for the lexicon data arranged by uniquely defined code value;
computer code for, upon a request to search for a word, identifying words having a matching initial character as the searched-for word; and
computer code for searching through the identified words for an identified word that matches the searched-for word.

9. The computer program product of claim 8, further comprising computer code for, before or during searching through the identified words for an identified word that matches the searched-for word, loading one or more words having the same initial character as the searched-for-word.

10. The computer program product of claim 8, wherein the lexicon data is arranged in ascending order by uniquely defined code value.

11. The computer program product of claim 8, wherein the language is Chinese.

12. The computer program product of claim 8, wherein the language is Japanese.

13. The computer program product of claim 8, wherein the computer software program comprises a speech recognition program.

14. The computer program product of claim 8, wherein the computer software program comprises a text-to-speech synthesis program.

15. An electronic device, comprising:
a processor and
a memory unit operatively connected to the processor,
wherein the memory unit and the processor cooperate to extract information from a lexicon and use the information with a computer software program, the extraction and use comprising the steps of:
arranging lexicon data for the language using uniquely defined code values for characters of words included in the lexicon;
creating a location array for the lexicon data arranged by uniquely defined code value;
upon a request to search for a word, identifying words having a matching initial character as the searched-for word; and
searching through the identified words for an identified word that matches the searched-for word.

16. The electronic device of claim 15, wherein the extraction and use further comprises for the step of, before or during searching through the identified words for an identified word that matches the searched-for word, loading one or more words having the same initial character as the searched-for-word.

17. The electronic device of claim 15, wherein the lexicon data is arranged in ascending order by uniquely defined code value.

18. The electronic device of claim 15, wherein the language is selected from the group consisting of Chinese and Japanese.

19. The electronic device of claim 15, wherein the computer software program comprises a speech recognition program.

20. The electronic device of claim 15, wherein the computer software program comprises a text-to-speech synthesis program.
